(19) United States
(12) Patent Application Publication
(10) Pub. No.: US 2005/0123343 A1
(43) Pub. Date: Jun. 9, 2005

(54) File binding system

(76) Inventor: John F. Suess JR., Woodlawn, VA (US)

Correspondence Address: Michael S. Neustel, Suite No. 4, 2534 South University Drive, Fargo, ND, 58103, US

(21) Appl. No.: 10/733,525

(22) Filed: Dec. 9, 2003

(51) Int. Cl. B42F 3/00; B42F 13/02

(52) U.S. Cl. 402/8

(57) ABSTRACT

A file binding system for efficiently securing documents within a file. The file binding system includes an elastic loop member, a bead member attached to the loop member and a locking member slidably positioned about the loop member. The locking member frictionally engages the loop member for allowing reduction or enlargement of the loop member. The locking member is preferably comprised of a ring structure with an aperture sized to frictionally receive the loop member. The locking member is positioned between the bead member and a distal portion of the loop member.

### CROSS REFERENCE TO RELATED APPLICATIONS

This application relates to a second application expected to be filed at the same time as this application identified by Attorney Docket No. SUES-001.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to document retention devices and more specifically it relates to a file binding system for efficiently securing documents within a file.

2. Description of the Related Art

Files have been in use for years. Conventional files are comprised of a folder structure that is capable of receiving and retaining a plurality of documents. Conventional files have two opposing walls that are pivotally attached to one another by a hinge portion. The files are typically comprised of a solid piece of rigid paper material.

The main problem with conventional files is that documents within the files are prone to being accidentally removed during transporting of the files. Another problem with conventional files is that the documents inside often times extend outwardly from the perimeter of the files thereby cluttering the files and placing the documents in a position which may result in damage to the documents.

One solution commonly utilized to retain documents within files is the usage of rubber bands. The rubber bands are secured about the file to assist in retaining the documents within the file. The main problem with rubber bands is that they do not provide the desired tension about the file. If a shorter or thicker rubber band is utilized, too much contraction force is applied to the file causing the file and documents within to become deformed. If a longer or thinner rubber band is utilized, not enough contraction force is applied to the file to adequately retain the documents within the file. Another problem is that files with more documents within are capable of receiving stronger rubber bands while files with few documents within are capable of receiving only weaker rubber bands. A further problem with rubber bands is that they are prone to breakage and tangling. Another problem with rubber bands is that the user must purchase numerous rubber bands of different thicknesses and lengths to accommodate various sizes of files.

While these devices may be suitable for the particular purpose to which they address, they are not as suitable for efficiently securing documents within a file. Conventional file retention devices are not suitable for applying the desired amount of contraction force to a file with a plurality of documents being retained.

In these respects, the file binding system according to the present invention substantially departs from the conventional concepts and designs of the prior art, and in so doing provides an apparatus primarily developed for the purpose of efficiently securing documents within a file.

### BRIEF SUMMARY OF THE INVENTION

In view of the foregoing disadvantages inherent in the known types of document securing devices now present in the prior art, the present invention provides a new file binding system construction wherein the same can be utilized for efficiently securing documents within a file.

The general purpose of the present invention, which will be described subsequently in greater detail, is to provide a new file binding system that has many of the advantages of the document securing devices mentioned heretofore and many novel features that result in a new file binding system which is not anticipated, rendered obvious, suggested, or even implied by any of the prior art document securing devices, either alone or in any combination thereof.

To attain this, the present invention generally comprises an elastic loop member, a bead member attached to the loop member and a locking member slidably positioned about the loop member. The locking member frictionally engages the loop member for allowing reduction or enlargement of the loop member. The locking member is preferably comprised of a ring structure with an aperture sized to frictionally receive the loop member. The locking member is positioned between the bead member and a distal portion of the loop member.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a file binding system that will overcome the shortcomings of the prior art devices.

A second object is to provide a file binding system for efficiently securing documents within a file.

Another object is to provide a file binding system that is capable of providing the desired amount of contraction force to a file.

An additional object is to provide a file binding system that is resistant to breakage and entanglement.

A further object is to provide a file binding system that may be utilized upon various sizes of files.

Another object is to provide a file binding system that may be reused numerous times.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is an upper perspective view of the present invention with the locking member lowered along the loop member.

FIG. 3 is an upper perspective view of the present invention loosely positioned about a file with documents.

FIG. 4 is an upper perspective view of the present invention secured about a file with documents.

FIG. 5 is an upper perspective view with two loop members secured about a file with documents.

FIG. 6 is an end view of the present invention secured about a file with documents.

FIG. 7 is a top view with two loop members secured about a file in a transverse manner.

### DETAILED DESCRIPTION OF THE INVENTION

A. Overview

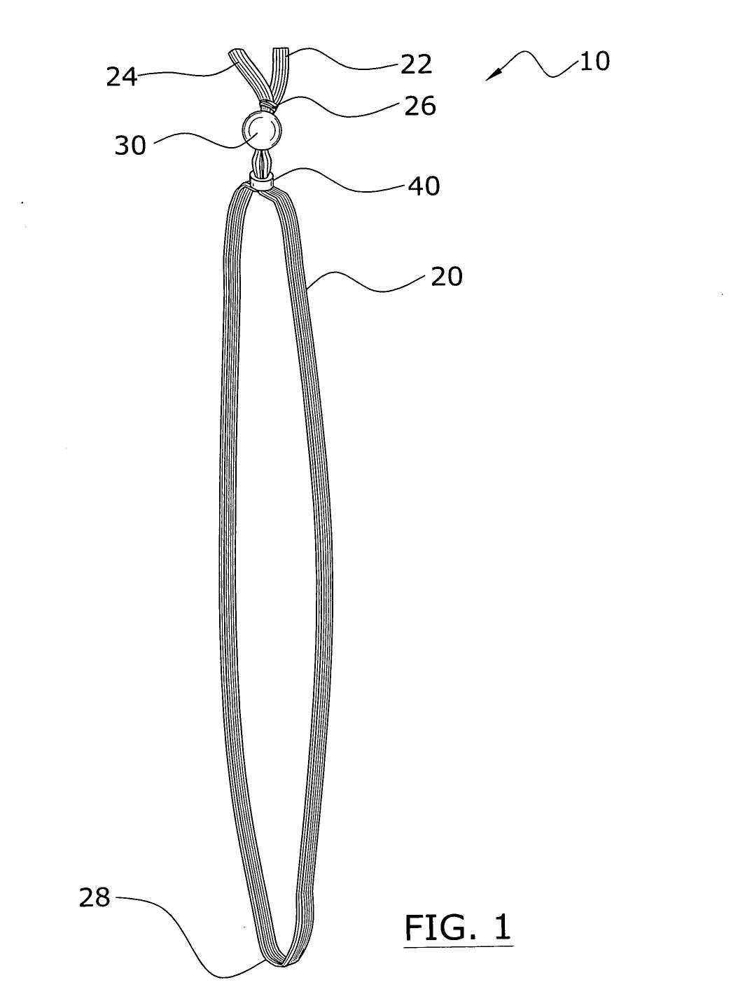

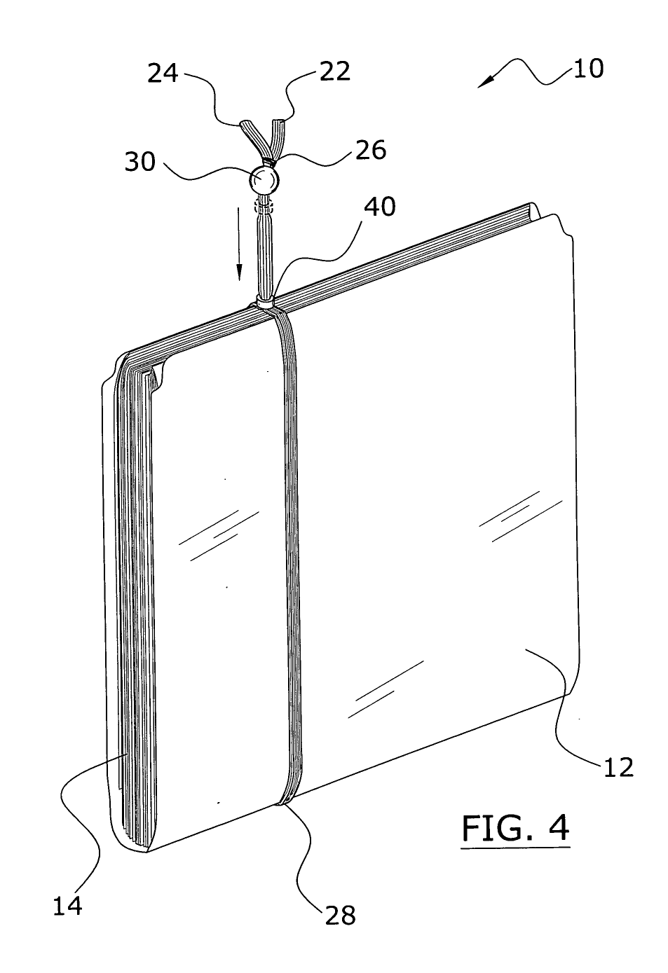

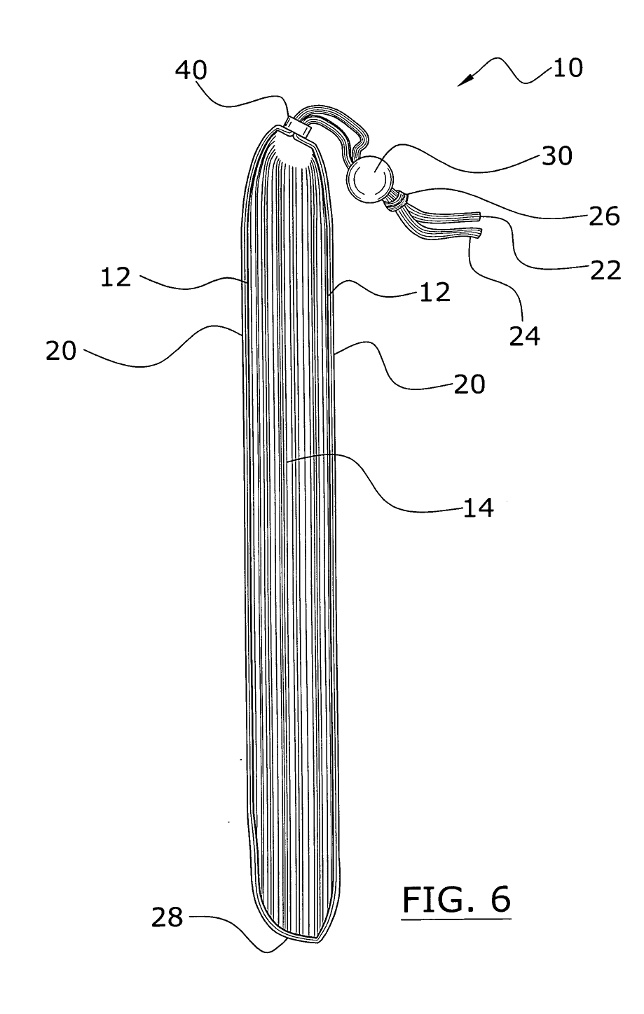

Turning now descriptively to the drawings, in which similar reference characters denote similar elements throughout the several views, FIGS. 1 through 7 illustrate a file binding system 10, which comprises an elastic loop member 20, a bead member 30 attached to the loop member 20 and a locking member 40 slidably positioned about the loop member 20. The locking member 40 frictionally engages the loop member 20 for allowing reduction or enlargement of the loop member 20. The locking member 40 is preferably comprised of a ring structure with an aperture sized to frictionally receive the loop member 20. The locking member 40 is positioned between the bead member 30 and a distal portion 28 of the loop member 20.

B. Elastic Loop Member

FIGS. 1 through 7 illustrate the elastic loop member 20. The loop member 20 may be comprised of a solid loop structure. The loop member 20 may also be comprised of an elongate member having a first end 22 and a second end 24 secured together forming the loop member 20. The first end 22 and the second end 24 are secured together by a knot 26 or other securing structure.

The loop member 20 is preferably comprised of an elastic flat band structure as best shown in FIG. 1 of the drawings. In addition, the loop member 20 is preferably comprised of a flexible stretchable fabric with interwoven strands of elastic material which is commonly utilized within the textile industry.

C. Bead Member

A bead member 30 is attached to the loop member 20 opposite of the distal portion 28 of the loop member 20 as shown in FIG. 1 of the drawings. The bead member 30 is positioned adjacent to the knot 26 of the loop member 20 as further shown in FIG. 1 of the drawings.

The bead member 30 is preferably comprised of a spherical structure or other broad structure capable of being easily grasped by the user. The bead member 30 is also preferably larger than the locking member 40 as best shown in FIG. 1 of the drawings.

D. Locking Member

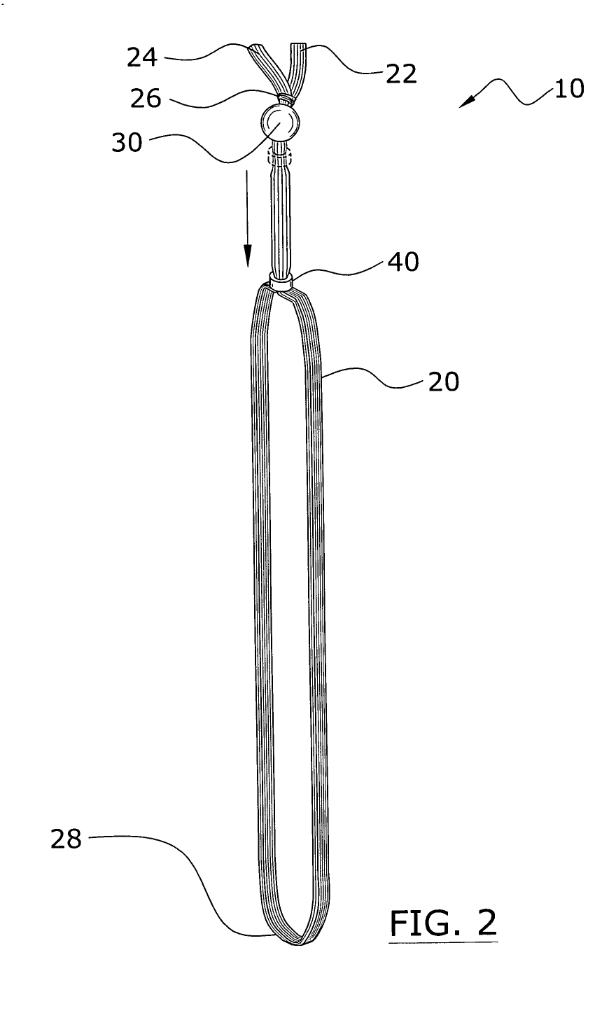

The locking member 40 is slidably positioned about the loop member 20 for allowing reduction or enlargement of an opening within the loop member 20 as shown in FIG. 2 of the drawings. The locking member 40 is positioned between the bead member 30 and the distal portion 28 of the loop member 20 as shown in FIG. 1 of the drawings. The locking member 40 receives the two opposing band portions of the loop member 20 as best illustrated in FIGS. 1 and 2 of the drawings.

The locking member 40 preferably frictionally engages the loop member 20 for retaining a desired position for the locking member 40 along the loop member 20. Various other locking means may be utilized for securing the locking member 40 along a desired location of the loop member 20.

The locking member 40 is preferably comprised of a ring structure with an aperture that frictionally receives the loop member 20. The locking member 40 may be comprised of other structures capable of resizing the loop member 20.

E. Operation of Invention

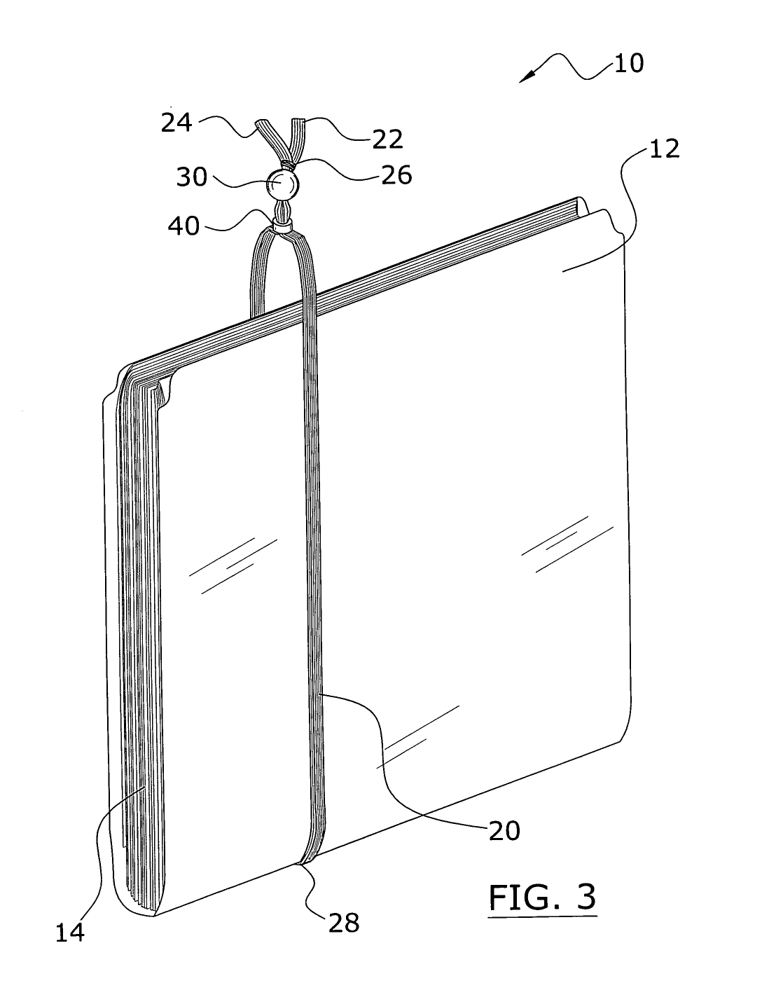

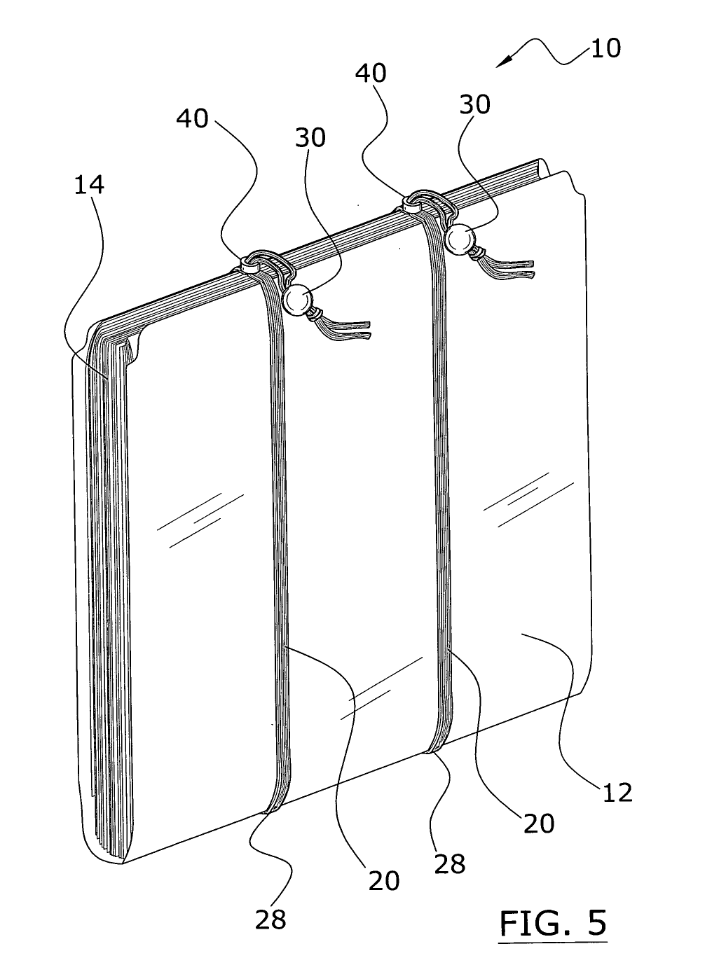

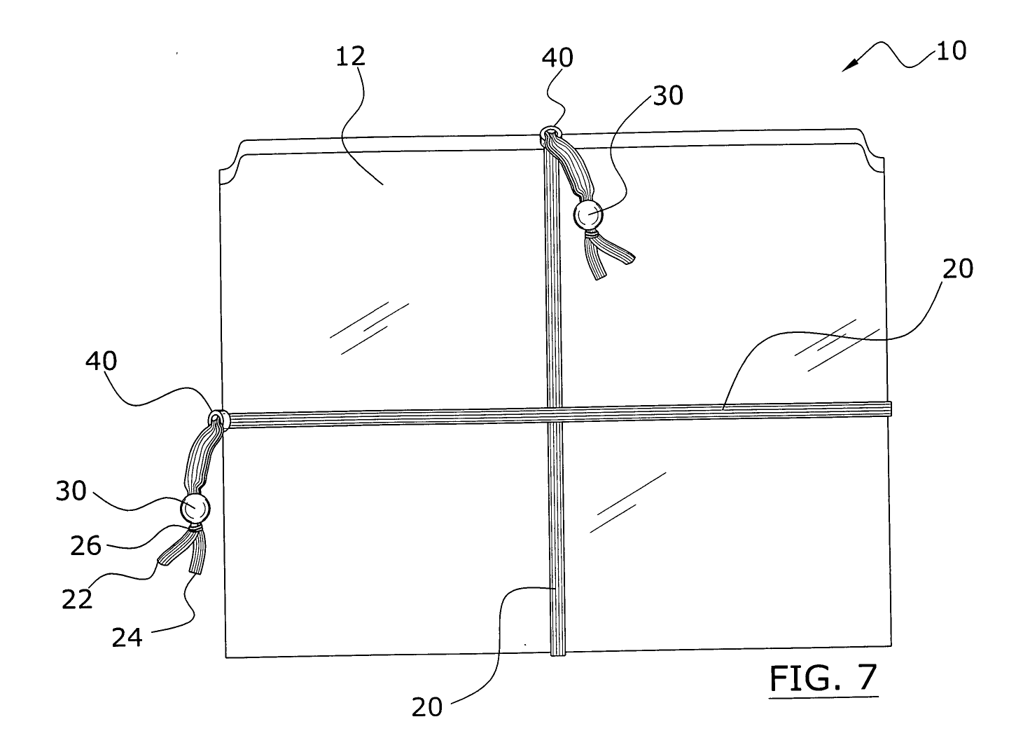

As shown in FIG. 3 of the drawings, the loop member 20 is positioned about the file 12 with one or more documents 14 within. The user then grasps the bead member 30 and the locking member 40, thereafter spreading the bead member 30 and the locking member 40 apart. The spreading of the bead member 30 and the locking member 40 causes the locking member 40 to slide along the loop member 20 thereby contracting the loop member 20 about the file 12. The user continues sliding the locking member 40 along the loop member 20 until the desired contraction force upon the file 12 is achieved. The user may secure additional loop members 20 about the file 12 in various patterns as shown in FIGS. 5 and 7 of the drawings.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. (canceled)

2. (canceled)

3. (canceled)

4. (canceled)

5. (canceled)

6. (canceled)

7. (canceled)

8. (canceled)

9. (canceled)

10. A file binding system, comprising:
an elastic loop member;
a bead member attached to said loop member; and
a locking member slidably positioned about said loop member, wherein said locking member frictionally engages said loop member for allowing reduction or enlargement of an opening within said loop member and wherein said locking member is positioned between said bead member and a distal portion of said loop member;
wherein said locking member is comprised of a ring structure with an aperture;
wherein said aperture is sized to frictionally receive said loop member;
wherein said loop member is comprised of a solid loop structure;
wherein said bead member is comprised of a spherical structure;
wherein said bead member is larger than said locking member;
wherein said loop member is comprised of an elastic flat band structure;
wherein said loop member is comprised of a flexible stretchable fabric with interwoven strands of elastic material.

11. A method of securing a file binder about a file, said file binder comprised of an elastic loop member, a bead member attached to said loop member, and a locking member slidably positioned about said loop member, wherein said locking member frictionally engages said loop member for allowing reduction or enlargement of an opening within said loop member and wherein said locking member is positioned between said bead member and a distal portion of said loop member, said method comprising the steps of:
(a) providing a file containing one or more documents within;
(b) positioning said loop member about said file;
(c) grasping said bead member and said locking member;
(d) separating said bead member and said locking member causing said locking member to slide downwardly upon said loop member thereby tightening said loop member upon said file;
(e) terminating said separating after a desired contraction force is applied to said file by said loop member; and
(f) repeating steps (b) through (e) if another loop member is desired to be secured about said file.

12. The method of securing a file binder about a file of claim 11, wherein said locking member is comprised of a ring structure with an aperture.

13. The method of securing a file binder about a file of claim 12, wherein said aperture is sized to frictionally receive said loop member.

14. The method of securing a file binder about a file of claim 11, wherein said loop member is comprised of a solid loop structure.

15. The method of securing a file binder about a file of claim 11, wherein said loop member is comprised of an elongate member having a first end and a second end secured together forming said loop member.

16. The method of securing a file binder about a file of claim 15, wherein said first end and said second end are secured together by a knot.

17. The method of securing a file binder about a file of claim 11, wherein said bead member is comprised of a spherical structure.

18. The method of securing a file binder about a file of claim 11, wherein said bead member is larger than said locking member.

19. The method of securing a file binder about a file of claim 11, wherein said loop member is comprised of a flexible stretchable fabric with interwoven strands of elastic material.
